(19) United States
(12) Patent Application Publication
(10) Pub. No.: US 2008/0181373 A1
(43) Pub. Date: Jul. 31, 2008

(54) Call Messaging System

(76) Inventors: Thomas W. Brown, Jr., Jackson, NJ (US); James L. Knight, Old Bridge Township, NJ (US)

Correspondence Address: Ryan, Mason & Lewis, LLP, 90 Forest Avenue, Locust Valley, NY, 11560, US

(21) Appl. No.: 11/669,430

(22) Filed: Jan. 31, 2007

(51) Int. Cl. H04M 11/00; H04M 3/42

(52) U.S. Cl. 379/88.13; 379/212.01

(57) ABSTRACT

Call messaging techniques are disclosed that allow a called party and a calling party to communicate without interfering with an on-going call in which the called party is participating, and enable the called party to communicate with the calling party even after the call has left the called party's endpoint. For example, a call messaging methodology includes the following steps. Information is maintained regarding an endpoint location of a call within a call switching system handling the call, wherein the call is placed by a calling party to a called party, but wherein the called party is not answering the call. In accordance with the methodology, a message channel is provided between the called party and the calling party, such that the called party and the calling party are able to communicate without having a call connection established between them. Further, a call connection is established between the calling party and the called party when the called party becomes available to answer the call, even when the call has moved to an endpoint in the call switching system other than an endpoint of the called party.

### FIELD OF THE INVENTION

The invention relates generally to the field of communication systems, and more particularly to a technique for providing a call messaging methodology that allows a called party and a calling party to communicate without interfering with an on-going call in which the called party is participating, and that permits such communication without regard to where the call is within the call switching system.

### BACKGROUND OF THE INVENTION

In a communication system, assume a scenario where a first person is participating in a telephone call with a second person, and a third person places a telephone call to the first person. Since the first person (“the called party”) is busy on the call with the second person, the third person (“the calling party”) will receive a busy signal on his communication device indicating that the first person is not currently available. In such a case, the first person would not know that he missed the attempted call, unless the first person has a voicemail service and a message is left thereon by the third person.

However, if the first person has a call-waiting service, the first person is alerted to the incoming call, allowing the first person to place the on-going call with the second person on hold and to take the incoming call from the third person.

If the first person's communication equipment has caller identification (ID) capability, the first person may also be alerted to the telephone number, and possibly the name of the third person, so that the first person can decide whether or not to place the on-going call with the second person on hold and take the incoming call from the third person.

Now assume that the first person is currently working on his personal computer while engaged in a call with the second person. There is a technology known as Computer Telephony Integration (CTI) that allows activities on a telephone and a computer to be integrated and coordinated. In fact, CTI also enables a computer to act as a call center, accepting incoming calls and routing them to an appropriate device or person. In such a case, the Session Initiation Protocol (SIP) is an application-level control protocol that may be used for redirecting, setting up and tearing down communication sessions with one or more participants. Such sessions may typically involve Internet telephone calls using so-called Voice over Internet Protocol (VoIP).

While CTI might enable the first person to obtain, at his computer, caller ID information regarding the call request from the third person, existing utilizations of CTI technology do not allow the first person and the third person to engage in meaningful real-time communication that would not interfere with other on-going calls that the first person is participating in, i.e., the call between the first person and the second person.

Existing utilizations of CTI technology also do not allow the called party to communicate with the calling party once the call has left the called party's endpoint within the call switching system, e.g., once the call has transferred to a voicemail endpoint or an attendant endpoint.

It is apparent from the foregoing that a need exists for call messaging techniques that allow a called party and a calling party to communicate without interfering with an on-going call in which the called party is participating, and that enable the called party to communicate with the calling party even after the call has left the called party's endpoint.

### SUMMARY OF THE INVENTION

Principles of the present invention provide call messaging techniques that allow a called party and a calling party to communicate without interfering with an on-going call in which the called party is participating, and enable the called party to communicate with the calling party even after the call has left the called party's endpoint.

For example, in one aspect of the invention, a call messaging methodology includes the following steps. Information is maintained regarding an endpoint location of a call within a call switching system handling the call, wherein the call is placed by a calling party to a called party, but wherein the called party is not answering the call. In accordance with the methodology, a message channel is provided between the called party and the calling party, such that the called party and the calling party are able to communicate without having a call connection established between them. Further, a call connection is established between the calling party and the called party when the called party becomes available to answer the call, even when the call has moved to an endpoint in the call switching system other than an endpoint of the called party.

The message channel provision step may further include permitting the called party or the calling party to send one or more messages to the other party. The one or more messages may be selected from a pre-stored set of messages or composed in real-time by the sender. The one or more messages from the calling party may be presented to the called party as text on a display of a computing device of the called party, such as not to interfere with another call in which the called party is currently participating. Such messages from the calling party may be indicative of the nature of the intended call. Further, the one or more messages from the called party may be audibly presented to the calling party on a communication device that the calling party is using to place the call. Such messages from the called party may be indicative of the future availability of the called party.

Further, the message channel provision step may further include presenting a menu of messaging options to the calling party. The menu of messaging options may be generic or specific to the calling party. A time delay loop may be maintained to control the amount of time the calling party waits for a response from the called party. The message channel provision step may further include providing the calling party with a message that the called party is now available, while the calling party is at an endpoint other than the called party's endpoint. Also, the message channel provision step may be enabled, at least in part, via a computer telephony integration-based function.

Still further, in accordance with the inventive methodology, the call connection between the calling party and the now-available called party may be established by the call switching system even though the calling party is at another endpoint, e.g., a voice mail, a call attendant, an automated attendant, a music-on-hold wait queue, a paging extension, or a conventional phone extension.

In another aspect of the invention, apparatus for handling a call placed by a calling party to a called party, wherein the called party is not answering the call, includes: a memory; and at least one processor coupled to the memory and operative to: (i) cause maintenance of information regarding an endpoint location of the call within a call switching system which is handling the call; (ii) cause provision of a message channel between the called party and the calling party, such that the called party and the calling party are able to communicate without having a call connection established between them; and (iii) cause establishment of a call connection between the calling party and the called party when the called party becomes available to answer the call, even when the call has moved to an endpoint in the call switching system other than an endpoint of the called party.

The memory and the at least one processor may be part of a computing device of the called party. The computing device of the called party may execute a call messaging application to cause performance of one or more of the maintenance, provision and establishment operations. The computing device of the called party may communicate with the calling party via a voice interaction unit, and with the call switching system via a computer telephony integration-based call control function.

In a yet another aspect of the invention, a call messaging application for handling a call placed by a calling party to a called party, wherein the called party is not answering the call, includes: program code for causing the maintenance of information regarding an endpoint location of the call within a call switching system which is handling the call; program code for causing the provision of a message channel between the called party and the calling party, such that the called party and the calling party are able to communicate without having a call connection established between them; and program code for causing the establishment of a call connection between the calling party and the called party when the called party becomes available to answer the call, even when the call has moved to an endpoint in the call switching system other than an endpoint of the called party.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates components of a communication environment within which techniques of the invention may be implemented.

FIGS. 2A through 2C illustrate a call messaging methodology according to an embodiment of the invention.

FIG. 3 illustrates a computing architecture of a device for use in implementing a call messaging methodology according to an embodiment of the invention.

### DETAILED DESCRIPTION OF PREFERRED EMBODIMENTS

It is to be appreciated that while the present invention may occasionally be described below in the context of a corporate voice communication network, the invention is not so limited. That is, the present invention is more generally applicable to any communication network in which it would be desirable to provide a call messaging methodology that allows a called party and a calling party to communicate without interfering with an on-going call that the called party is participating in, and that permits such communication without regard to where the call is within the call switching system. Thus, techniques of the invention can conceivably be implemented with any type of communication devices (e.g., smartphones, cellular phone, voice-capable personal digital assistant, etc.), and any type of communication system (e.g., wireless, wired, etc.).

It is also to be understood that, in describing the various embodiments of the invention below, we utilize as an example the call scenario mentioned above in the background section i.e., first party (called party), second party (party having on-going call with first party), and third party (calling party).

As will be illustratively described below, a call messaging application of the invention uses CTI technology to monitor the status of an end-user's (called party) telephone or telephony device. A determination is made as to whether: (i) the called party is available to answer an incoming call; and (ii) the called party is currently using a messaging application of the type described herein. If the answer to (i) is NO and the answer to (ii) is YES, then an automatic communication is initiated with the calling party whereby the calling party can be provided with information about the called party's status and can submit messages to be displayed on the called party's computer or telephony device. The call messaging application is made aware of a “busy” or “unable-to-answer” status of the called party and of the arrival of a call at the called party's telephone. The application displays to the called party any messages submitted by the caller. The called party is also able to enter and send a communication to the calling party.

If the calling party call moves away from the called party's phone (perhaps by a “call coverage” feature such as “forward on no-answer”) before the called party answers it, the status of the call is continually monitored, using CTI events, by the system. Status may include the endpoint device (e.g., another phone, a voice mail system, a call-waiting queue, etc.) at which the calling party call is currently terminated and the state (ringing, answered, on-hold, etc.) of the call at the terminating device.

The originally-called party is apprised, via a visual display on their PC or telephony device, whether, on the basis of the calling party's call's status, the call can be controlled (via CTI services and events) and ultimately be retrieved by the system.

If the now-available, originally-called party wishes to now communicate with the caller (whose call is no longer at the originally-called party's telephone, but which call is still known and accessible via CTI services), principles of the invention provide a mechanism to: (i) query the calling party as to whether they still wish to communicate with the originally-called party and query in such a way as to not interfere with the calling party's current call; (ii) allow the calling party to provide a controlling response; (iii) indicate the calling party's response to the originally-called party; and (iv) if the calling party still wishes to communicate with the originally called party, establish such communication.

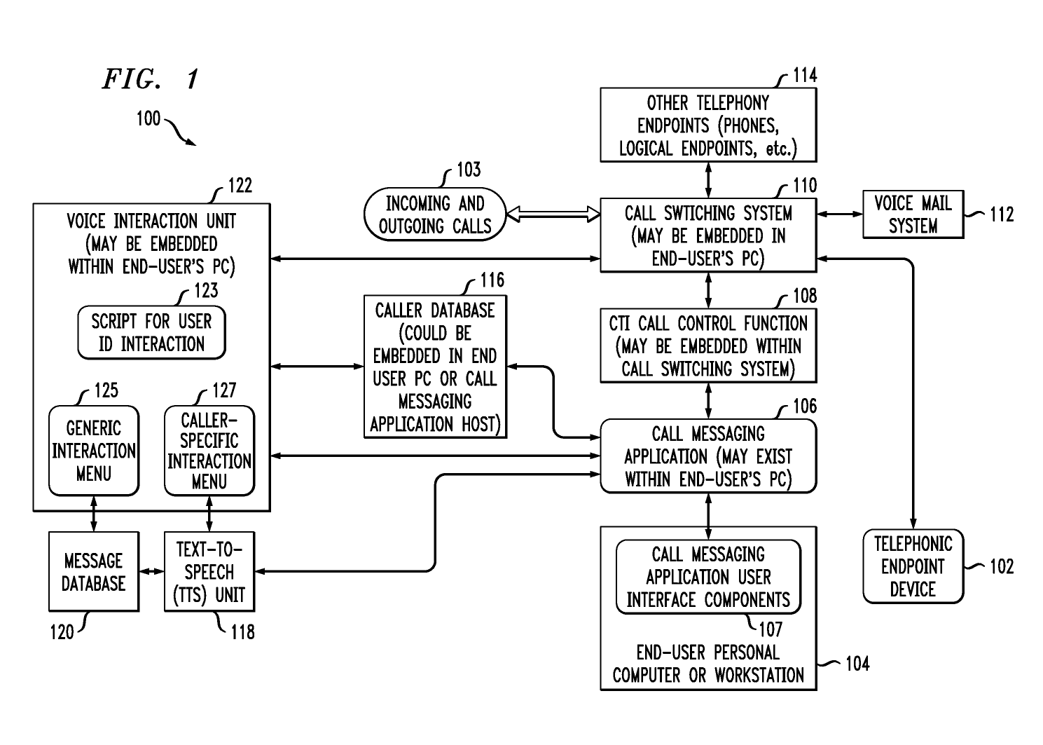

Referring initially to FIG. 1, components of a communication environment within which techniques of the invention may be implemented are illustrated. As shown, environment 100 includes telephonic endpoint device 102 (i.e., the called party's communication device), end-user personal computer or workstation 104 (i.e., called party's computer), call messaging application 106, call messaging application user interface 107, CTI call control function 108, call switching system 110, voicemail system 112, other telephony endpoints (e.g., phones, logical endpoints, etc.) 114, caller database 116, text-to-speech (TTS) unit 118, message database 120, and voice interaction unit 122 including user ID interaction script 123, generic interaction menu 125 and caller-specific interaction menu 127. Also shown are any incoming or outgoing calls 103. With reference to the call scenario mentioned above in the background section, it is understood that the third person's call (the calling party's call) would be one of the incoming calls 103.

As used herein, an “endpoint” is a logical terminus of one leg of a call, a “leg” representing one call participant's connection to or association with the call. This logical terminus is typically assigned a logical address such as a telephone or extension number and is often, but not necessarily, associated with a physical device such as a telephone, fax machine, automated voice answering machine, and the like.

Note also that FIG. 1 illustratively indicates where certain of the components depicted may reside, e.g., in the end-user's computer, in the call switching system, in a call messaging application host. It is to be understood that the call messaging host might be (and typically is, at least in part) embodied as the end-user's desktop computer, or might be wholly or partially embodied as an entirely separate and dedicated computer, possibly providing application services to many end-users. While these are examples of how the environment may be configured, it is to be understood that the principles of the invention are not limited to this particular configuration.

The illustrative environment shown in FIG. 1 may be part of a corporate voice communication network, wherein call switching system 110 may be a PBX (Public Branch Exchange) and the called party's communication device (endpoint 102) and one or more other communication devices (endpoints 114) may be PBX extensions. The communication device of the calling party (i.e., the third person in the running illustrative scenario) may or may not be part of the corporate network.

It is to be appreciated that any appropriate communication protocol or protocols can be used to conduct voice calls. By way of example, the voice call can be handled by a Session Initiation Protocol (SIP)-based Voice over Internet Protocol (VoIP). However, the invention is not limited to any particular communication protocol. Also, while CTI is described as the illustrative protocol for conveying messages and information between the phone system and the called party's computer system, the invention is not limited to any such protocol.

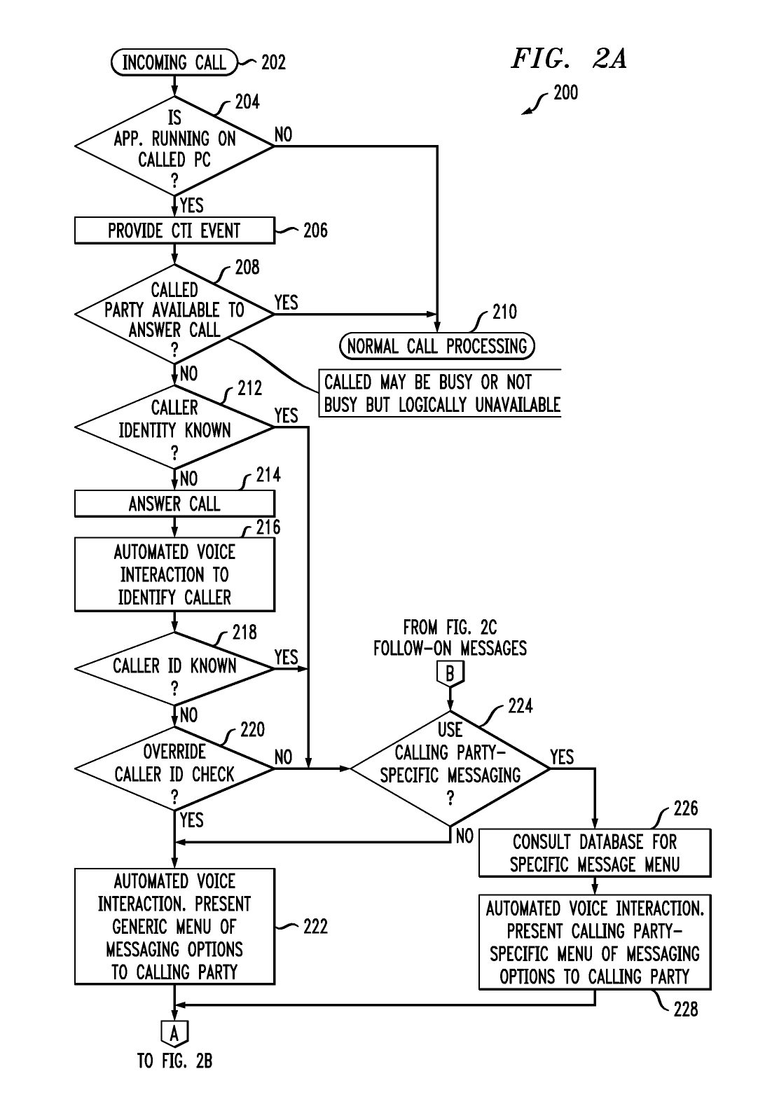

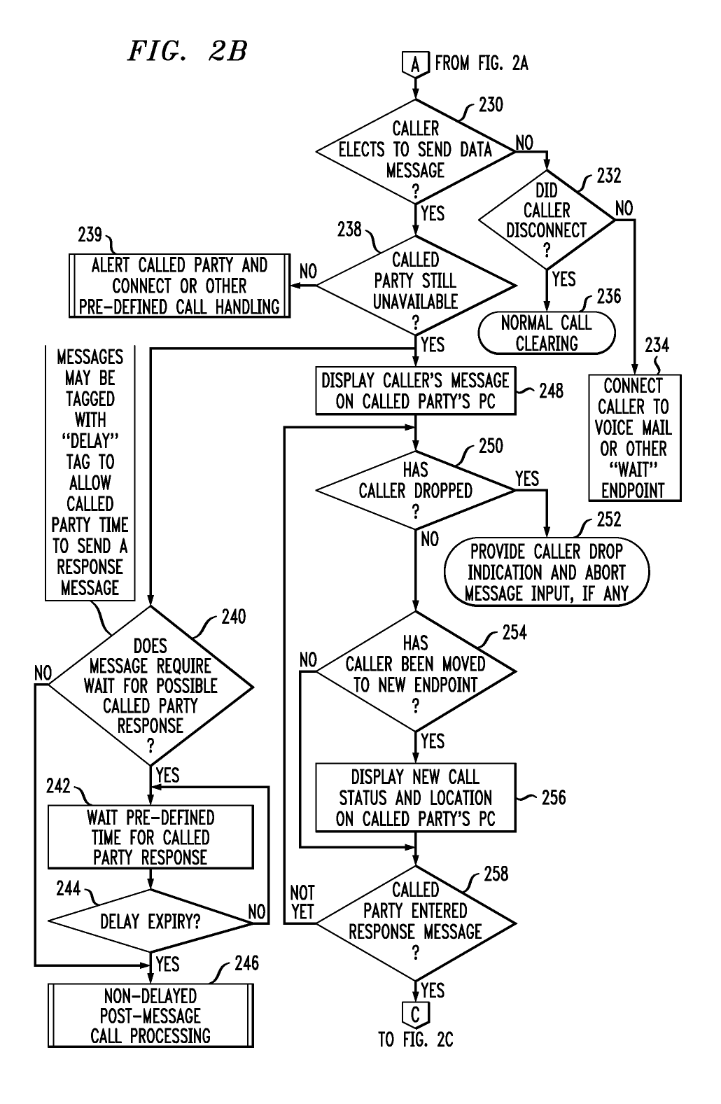

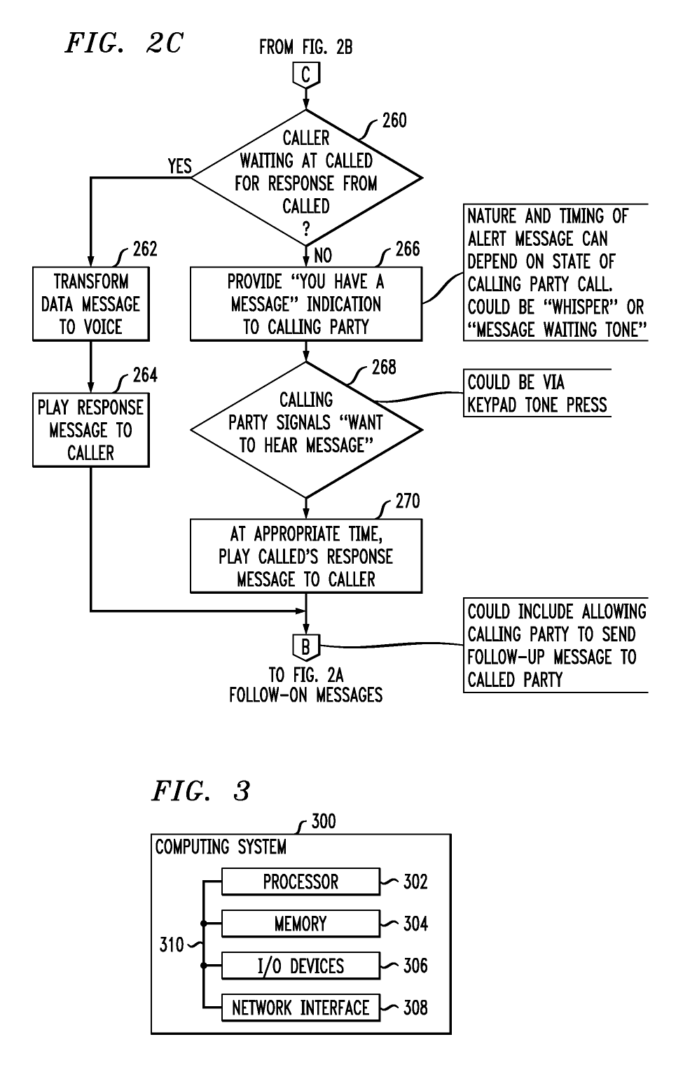

Given the components of communication environment 100 depicted in FIG. 1, a call messaging methodology 200 according to an embodiment of the invention will now be described in the context of FIGS. 2A through 2C.

Incoming call 202 arrives at call switching system 110, which identifies the called party as the intended recipient of the call. In terms of the running illustrative scenario, this would be the call from the third person (calling party) trying to reach the first person (called party).

In step 204, a check is performed to determine whether or not call messaging application 106 is currently running on called party's computer. If yes, and if a CTI session exists between the called party and the call switching system, a CTI event is provided (in step 206) by CTI call control function 108 to call messaging application 106, informing the application of the incoming call.

The call messaging application determines (step 208), via CTI events provided by the CTI call control function and by end user input, the called party's availability to accept the incoming call. For example, the called phone may be busy (on a call with the second person in the running illustrative scenario) or the called party may have set a “Do Not Disturb” flag in the call messaging application or in the phone system.

If the called party is available to handle the call or the call messaging application is not running at the called party, the call is processed normally and delivered to the called party who can answer it and converse with the caller (step 210).

If the identity of the calling party is not provided in the CTI event that advised the call messaging application of the incoming call, and therefore not known (step 212), the call may be answered (step 214) and handled by automated voice interaction unit 122. The voice interaction unit follows user identification script 123 and interrogates the caller in an attempt to determine the caller's identity (step 216). For example, the script may ask the caller to enter a “Customer Number,” “Account Number” or the like. If the caller provides such information, the voice interaction unit provides the entered information to the call messaging application via CTI events (such as a “Digits Collected” CSTA event). At the conclusion of the voice interaction unit operation, the call is again controlled by the call messaging application, which can determine how it is to be handled further.

Call messaging application 106 may determine a specific menu of messaging options that should be presented to the calling party. The specific menu that is presented can be controlled, for example, by CTI call control service requests from the call message application, via CTI call control function 108, to call switching system 110 that moves the call to a specific logical endpoint controlled by the voice interaction unit and associated with a specific menu of audio message options. For example, extension 2345 may be a voice unit-controlled extension that is configured to present “Option Menu A” to all calls delivered to it.

If the voice interaction unit fails to identify the unknown caller (step 218) and if the caller ID check is not overridden (step 220), the call messaging application may cause generic audio menu 125 of messaging options to be presented to the caller by the voice interaction unit (step 222). This may include options/statements such as:
a. Called Party Can't Take Your Call Now but can get text messages. Press 1 to give a text message;
   or Press 2 to leave a Voice Mail Message.
b. (If “1” is pressed)
   i. Press 1 to tell called party your call is urgent and you will wait for them to pick up.
   ii. Press 2 to tell called party you will call back shortly.

Messages output by the voice interaction unit may be stored as text on message database 120 and converted to speech by TTS unit 118. On the other hand, caller database 116 shown in FIG. 1 would be used to personally identify callers (e.g., incoming call is from 123-4567—that's one of my family members) and thereby allow an appropriate menu of options (“Call Home” vs. “To reach my secretary, press 3”) to be selected and presented. Such a caller database might be a personal one stored on the end-user's PC, while the message database contains the actual set of messages. That is, once it is decided that the “Family Member Menu” should be presented, the appropriate messages would be retrieved from the message database. These might be in the form of .wav files that could be used directly or in the form of text data that would need to be converted via TTS into audio.

If the calling party has been identified (step 218), or if the caller ID check has been overridden (step 220), caller-specific audio menu 127 may be provided to the caller (step 224). Message database 120 may be consulted (step 226) to retrieve, based on the caller's identity (see above), the specific of message options to be presented (step 228). For example, if the caller is a family member of the called party, a special menu of message options for family members could be presented. This might include messages to present options like “Please call home.” The called party may elect to ignore the condition of the calling party being unidentified and provide a generic menu. This can be signalled by setting a flag in the call messaging application.

Whether the menu of messaging options presented by voice interaction unit 122 is generic or caller-specific, the voice interaction unit allows the caller to select and send text (data) messages (step 230) that the call message application can deliver and present on a visual display or monitor of the called party's personal computer (PC) or workstation if the called party is still unavailable (steps 238 and 248). The messages can inform the called party of the call's urgency; that the caller will continue to wait; that the caller will call back shortly, etc. Further, the voice interaction unit allows the caller to select an option to go to the called party's voice mail 112 or to an attendant or other call handling endpoint 114 (step 234).

Note that if the calling party decides not to send a message (step 230) and disconnects (step 232), the call is cleared from the system (step 236).

If the caller selects an option that includes waiting for the called party, the calling party call may be moved (by the call message application or by the voice interaction unit itself) from the voice interaction unit to the called party's phone to, for example, “wait there while on hold.”

It may happen that the called party becomes available (step 238) while the calling party is interacting with the voice interaction unit (e.g., listening to menu options, selecting a message to send to the called party, etc.). In this case (i.e., the called party becomes available), the calling party may be connected immediately to the called party or other normal (i.e., “called party available” message) processing may be applied in step 239 (forwarding may be applied, for example, if the called party has recently activated it). In such a case, there is now no need to present a text message to the called party.

Once a message has been selected and displayed on the called party's PC or workstation monitor, the called party may elect to answer the call, either via CTI commands issued by the call message application or by manipulating the phone. For example, if the caller's message indicates the call is “Urgent,” the called party may use telephone feature buttons to place a current call on hold and answer the calling party.

If the calling party has elected to wait for the called party to become available, a timing function may optionally be used to limit the amount of waiting time before the caller is given other options (e.g., “Press 1 to continue to wait or Press 2 to leave a voice mail message for called party”) or other call handling is automatically performed (e.g., automatically transferred to an attendant or voice mail). A time-out loop may be applied to control this process.

By way of one example, as shown, if the caller's message requires waiting for possible called party response (step 240), a delay loop is entered (steps 242 and 244). If the delay has expired, then some post-message call processing is performed (step 246).

Based on the calling party's message and identity (if known), the called party may elect to send an audio message to the caller who has decided to do something other than simply disconnect. For example, the calling party may have elected to wait for the caller, to be transferred to voice mail, or to speak with an attendant, etc. All of these cases have in common that the calling party's call remains active at some endpoint controlled by the call switching system.

The called party may select a predefined response message from a set offered by the call message application. The set may depend on the identity of the calling party and/or the message sent by the calling party. Alternatively, the call message application may allow the called party to compose a short custom response text message.

Whether a canned message is selected or a custom text message is composed, a text-to-speech converter (TTS unit 118) may be used to convert the data message to an audio representation that can be presented by the voice interaction unit (118) to the calling party. The voice interaction unit may retrieve an audio representation of the selected message from a database of messages (database 120), perhaps stored in digitized representation as “.wav” formatted files. Alternately, the “canned” messages may be stored as text, for example, and converted to audio by the text-to-speech converter (as is done with the custom text message.) While the called party is selecting or composing a response message, the calling party may, at any moment, decide to disconnect. If this occurs, there is no need for the response message and so the called party is informed (via a CTI event processed by the call message application) that the caller has disconnected (steps 250 and 252).

As mentioned above, the calling party, after sending a text message to the called party, may be given the option to transfer to voice mail or another endpoint at any time. It may happen that the calling party elects to transfer to another endpoint while the called party is selecting or composing a response message.

The change in status of the calling party's call (i.e., from waiting at the called party to being moved to another endpoint) becomes known to the call message application via a CTI event provided by the CTI call control function (step 254). The updated status/location of the calling party (or, more particularly, the call) is displayed to the called party who may be composing a response message (step 256).

If the called party has selected a canned response message or entered a custom text response message (step 258), the message is sent to the calling party.

If the calling party is still waiting for a response from the called party (step 260), the audio message is delivered by the voice interaction unit (steps 262 and 264). This could be accomplished, for example, by conferencing the voice interaction unit endpoint with the called party's extension or by numerous other techniques. Follow-on messaging can then occur.

If the calling party is no longer waiting at the called party extension, the called party may still wish the response message to be delivered to the caller. Since the calling party is still active within the call switching system, this is feasible.

Even if the caller is interacting with the voice mail system (i.e., leaving a voice mail for the called party) the response message entered by the called party can be presented by a variety of implementations. For example, an alert tone (or “whisper”) may be given to the calling party (now leaving a voice message) followed by a message such as “Press 1 to hear a message to you from Called_Party_Name” (step 266). This message may be presented by the voice interaction unit which may also be used to detect any key press response from the calling party. This functionality may be achieved by conferencing together the voice interaction unit with the voice mail endpoint, or by other techniques. In any case, the response message is delivered regardless of the current endpoint location of the calling party within the call switching system.

The calling party may provide an indication (e.g., via keypad tone press) that he wants to hear the message (step 268), and the message may then be played to the calling party (step 270).

Based on the response message (e.g., “Call me back in 5 minutes,” “I'll return your call shortly,” “I'll be free in 10 minutes,” etc.), the calling party can take appropriate action.

It is to be understood that given the many advantages of the call messaging application running on the called party's personal computer and being in communication with the various other components of the communication environment shown in FIG. 1, various call and message processing scenarios, other than those described above in the context of FIGS. 2A through 2C, are contemplated by principles of the invention.

Turning lastly to FIG. 3, a computing architecture 300 of a device for use in implementing a call messaging methodology, according to an embodiment of the invention, is illustrated. That is, FIG. 3 may be considered a computing architecture used to implement a communication device, a personal computer/workstation, a call switching system, a voice mail system, a voice interaction unit, a database, and/or a TTS unit, as shown in FIG. 1. Of course, it is to be understood that the invention is not limited to any particular computing system implementation.

In this illustrative implementation, a processor 302 for implementing at least a portion of the methodologies of the invention is operatively coupled to a memory 304, input/output devices 306, and a network interface 308 via a bus 310, or an alternative connection arrangement.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., hard drive), removable storage media (e.g., diskette), flash memory, etc.

In addition, the phrase “I/O devices” as used herein is intended to include one or more input devices (e.g., keyboard, mouse, etc.) for entering data to the processing unit, as well as one or more output devices (e.g., CRT display, etc.) for providing results associated with the processing unit.

Further, the phrase “network interface” as used herein is intended to include, for example, one or more devices capable of allowing the computing system to communicate with other computing systems. Thus, the network interface may comprise a transceiver configured to communicate with a transceiver of another computer system via a suitable communication protocol.

Accordingly, one or more computer programs, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of handling a call placed by a calling party to a called party, wherein the called party is not answering the call, comprising the steps of;
maintaining information regarding an endpoint location of the call within a call switching system which is handling the call;
providing a message channel between the called party and the calling party, such that the called party and the calling party are able to communicate without having a call connection established between them; and
establishing a call connection between the calling party and the called party when the called party becomes available to answer the call, even when the call has moved to an endpoint in the call switching system other than an endpoint of the called party.

2. The method of claim 1, wherein the message channel provision step further comprises permitting one of the called party and the calling party to send one or more messages to the other of the called party and the calling party.

3. The method of claim 2, wherein the one or more messages are selected from a pre-stored set of messages.

4. The method of claim 2, wherein the one or more messages are composed in real-time by the sender.

5. The method of claim 2, wherein the one or more messages from the calling party are presented to the called party as text on a display of a computing device of the called party, such as not to interfere with another call in which the called party is currently participating.

6. The method of claim 2, wherein the one or more messages from the calling party are indicative of the nature of the intended call.

7. The method of claim 2, wherein the one or more messages from the called party are audibly presented to the calling party on a communication device that the calling party is using to place the call.

8. The method of claim 2, wherein the one or more messages from the called party are indicative of the future availability of the called party.

9. The method of claim 1, wherein the message channel provision step further comprises presenting a menu of messaging options to the calling party.

10. The method of claim 9, wherein the menu of messaging options is generic.

11. The method of claim 9, wherein the menu of messaging options is specific to the calling party.

12. The method 1, wherein the message channel provision step further comprises maintaining a time delay loop to control the amount of time the calling party waits for a response from the called party.

13. The method of claim 1, wherein the message channel provision step further comprises providing the calling party with a message that the called party is now available, while the calling party is currently leaving a message at a voice mail endpoint, engaged at an attendant endpoint, or waiting at another endpoint.

14. The method of claim 13, wherein the call connection between the calling party and the now-available called party is established by the call switching system even though the calling party is at one of the other endpoints.

15. The method of claim 1, wherein the message channel provision step is enabled, at least in part, via a computer telephony integration-based function.

16. Apparatus for handling a call placed by a calling party to a called party, wherein the called party is not answering the call, comprising:
a memory; and
at least one processor coupled to the memory and operative to: (i) cause maintenance of information regarding an endpoint location of the call within a call switching system which is handling the call; (ii) cause provision of a message channel between the called party and the calling party, such that the called party and the calling party are able to communicate without having a call connection established between them; and (iii) cause establishment of a call connection between the calling party and the called party when the called party becomes available to answer the call, even when the call has moved to an endpoint in the call switching system other than an endpoint of the called party.

17. The apparatus of claim 16, wherein the memory and the at least one processor are part of a computing device of the called party.

18. The apparatus of claim 17, wherein the computing device of the called party executes a call messaging application to cause performance of one or more of the maintenance, provision and establishment operations.

19. The apparatus of claim 16, wherein the computing device of the called party communicates with the calling party via a voice interaction unit, and with the call switching system via a computer telephony integration-based call control function.

20. A call messaging application for handling a call placed by a calling party to a called party, wherein the called party is not answering the call, comprising:
program code for causing the maintenance of information regarding an endpoint location of the call within a call switching system which is handling the call;
program code for causing the provision of a message channel between the called party and the calling party, such that the called party and the calling party are able to communicate without having a call connection established between them; and
program code for causing the establishment of a call connection between the calling party and the called party when the called party becomes available to answer the call, even when the call has moved to an endpoint in the call switching system other than an endpoint of the called party.
